(19) United States
(12) Patent Application Publication
(10) Pub. No.: US 2023/0142243 A1
(43) Pub. Date: May 11, 2023

(54) DEVICE ENVIRONMENT IDENTIFICATION METHOD AND APPARATUS, ELECTRONIC DEVICE, AND AUTONOMOUS VEHICLE

(71) Applicant: Apollo Intelligent Driving Technology (Beijing) Co., Ltd., Beijing (CN)

(72) Inventors: Xitong WANG, Beijing (CN); Kuang HU, Beijing (CN); Jinping LIANG, Beijing (CN); Ming LIN, Beijing (CN); Kang WANG, Beijing (CN); Xiaoying CHEN, Beijing (CN)

(73) Assignee: Apollo Intelligent Driving Technology (Beijing) Co., Ltd., Beijing (CN)

(21) Appl. No.: 18/148,836

(22) Filed: Dec. 30, 2022

(30) Foreign Application Priority Data
May 25, 2022 (CN) 202210579962.1

(51) Int. Cl. G06T 7/80; G01S 7/40; G01S 7/41; G06F 18/22

(52) U.S. Cl. CPC G06T 7/80; G01S 7/40; G01S 7/41; G06F 18/22; G06T 2207/10028; G06T 2207/30252; G06T 2207/30244

(57) ABSTRACT

This disclosure provides a device environment identification method, a device environment identification apparatus, an electronic device and an autonomous vehicle, and relates to the field of artificial intelligence, in particular to the field of autonomous driving technology, sensor technology, etc. The method includes: obtaining data collected by a sensor of a device from an environment where the device is located; extracting feature information from the collected data; and generating an identification result of the environment in accordance with the feature information, the identification result being used for indicating a corresponding relationship between the environment and calibration of the sensor.

### TECHNICAL FIELD

The present disclosure relates to the field of artificial intelligence technology such as autonomous driving technology and sensor technology, in particular to a device environment identification method, a device environment identification apparatus, an electronic device, and an autonomous vehicle.

### BACKGROUND

Recently, many devices are provided with sensors so as to improve their performance. For example, an autonomous vehicle or a robot device is provided with a plurality of sensors. In order to ensure accuracy of sensor data, usually the sensor needs to be calibrated. Currently, a specialized person identifies a corresponding relationship between an environment and the calibration of the sensor, e.g., determines whether the environment meets the requirement of the calibration of the sensor.

### SUMMARY

In one aspect, the present disclosure provides in some embodiments a device environment identification method, including: obtaining data collected by a sensor of a device from an environment where the device is located; extracting feature information from the collected data; and generating an identification result of the environment in accordance with the feature information, the identification result being used for indicating a corresponding relationship between the environment and calibration of the sensor.

In another aspect, the present disclosure provides in some embodiments an electronic device, including at least one processor and a memory in communicative connection with the at least one processor. The memory is configured to store therein an instruction configured to be executed by the at least one processor, and the at least one processor is configured to execute the instruction to implement the above-mentioned device environment identification method.

In yet another aspect, the present disclosure provides in some embodiments a non-transitory computer-readable storage medium storing therein a computer instruction. The computer instruction is configured to be executed by a computer to implement the above-mentioned device environment identification method.

In still another aspect, the present disclosure provides in some embodiments an autonomous vehicle including the above-mentioned electronic device.

It should be understood that, this summary is not intended to identify key features or essential features of the embodiments of the present disclosure, nor is it intended to be used to limit the scope of the present disclosure. Other features of the present disclosure will become more comprehensible with reference to the following description.

### BRIEF DESCRIPTION OF THE DRAWINGS

The following drawings are provided to facilitate the understanding of the present disclosure, but shall not be construed as limiting the present disclosure. In these drawings,

FIG. 1 is a flow chart of a device environment identification method according to an embodiment of the present disclosure;

FIG. 2 is a schematic view showing a device environment identification method according to an embodiment of the present disclosure;

FIG. 3 is another schematic view showing a device environment identification method according to an embodiment of the present disclosure;

FIG. 4 is a schematic view showing a device environment identification apparatus according to an embodiment of the present disclosure;

FIG. 5 is another schematic view showing a device environment identification apparatus according to an embodiment of the present disclosure;

FIG. 6 is yet another schematic view showing a device environment identification apparatus according to an embodiment of the present disclosure; and

FIG. 7 is a block diagram of an electronic device according to an embodiment of the present disclosure.

### DETAILED DESCRIPTION

In the following description, numerous details of the embodiments of the present disclosure, which should be deemed merely as exemplary, are set forth with reference to accompanying drawings to provide a thorough understanding of the embodiments of the present disclosure. Therefore, those skilled in the art will appreciate that modifications or replacements may be made in the described embodiments without departing from the scope and spirit of the present disclosure. Further, for clarity and conciseness, descriptions of known functions and structures are omitted.

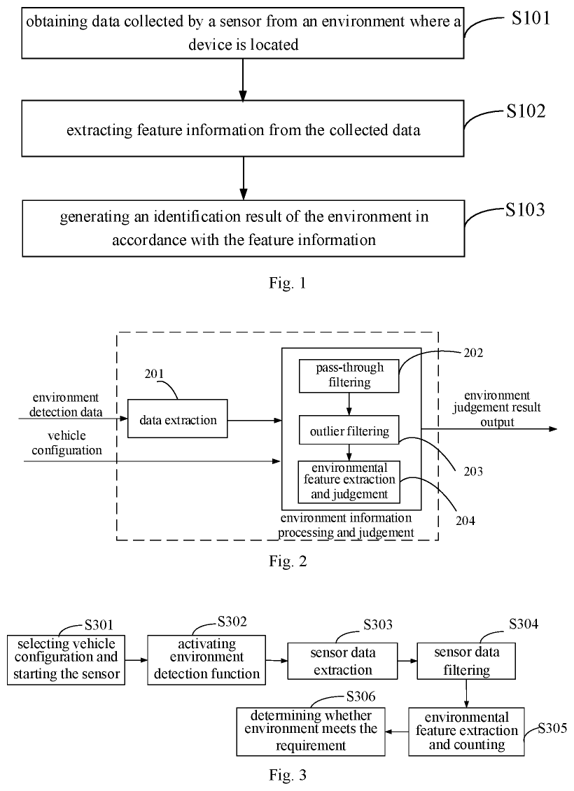

The present disclosure provides in some embodiments a device environment identification method, which, as shown in FIG. 1, includes the following steps S101, S102 and S103.

Step S101: obtaining data collected by a sensor of a device from an environment where the device is located.

The device may be a device having a sensor, e.g., a vehicle or a robot device, and the vehicle may be an autonomous vehicle or a non-autonomous vehicle.

The sensor may be a radar sensor or an image sensor installed in the device.

The environment where the device is located refers to an environment where the device is currently situated, e.g., a road, a square or the like where the device is currently situated.

The obtaining data collected by the sensor from the environment where the device is located may refer to: obtaining data collected by the sensor in real time from the environment where the device is located, or obtaining data collected by the sensor in advance from the environment where the device is located.

The collected data may also be called as sensor data, i.e., data collected by the sensor.

Step S102: extracting feature information from the collected data.

The feature information may be curvature information, normal vector information, feature histogram information or the like. The extracting the feature information from the collected data may refer to: extracting the feature information from all of or a part of the collected data.

Step S103: generating an identification result of the environment in accordance with the feature information, the identification result being used for indicating a corresponding relationship between the environment and calibration of the sensor.

The generating the identification result of the environment in accordance with the feature information may refer to: matching the feature information and predetermined environmental feature information for the calibration of the sensor, and generating the identification result in accordance with a match result. In case that the feature information matches the predetermined environmental feature information for the calibration of the sensor, the generated identification result is used for indicating the corresponding relationship that the environment meets the requirement of the calibration of the sensor, and in case that the feature information does not match the predetermined environmental feature information for the calibration of the sensor, the generated identification result is used for indicating the corresponding relationship that the environment does not meet the requirement of the calibration of the sensor.

Alternatively, the generating the identification result of the environment in accordance with the feature information may refer to: in case that the feature information indicates that there is a target object (e.g., a building, an obstacle or a pedestrian) in the environment, generating the identification result, the identification result being used for indicating the corresponding relationship that the environment meets the requirement of the calibration of the sensor; and in case that the feature information indicates that there is no target object (e.g., a building, an obstacle or a pedestrian) in the environment, generating the identification result, the identification result being used for indicating the corresponding relationship that the environment does not meet the requirement of the calibration of the sensor.

It is noted that, in some implementations, the corresponding relationship may indicate a position region in the environment that is suitable for the calibration of the sensor, or the corresponding relationship may indicate a position region in the environment that is unsuitable for the calibration of the sensor.

According to the embodiments of the present disclosure, through the above-mentioned steps, the identification result of the environment is generated based on the feature information of the data collected by the sensor. As a result, it is able to intelligently identify the environment without any specialized person, thereby improving the environment identification efficiency.

In addition, according to the embodiments of the present disclosure, no specialized person is required, so it is also able to reduce the manpower cost.

It should be noted that, the above-mentioned method may be executed by the device, e.g., all the steps in the method are executed by an autonomous vehicle or a robot device, so as to improve an environment identification function of the autonomous vehicle or robot device. In addition, in some embodiments of the present disclosure, the method may also be executed by an electronic device in communicative connection with the device, e.g., a server or a mobile phone in connection with the autonomous vehicle.

In a possible embodiment of the present disclosure, the method further includes filtering the collected data to obtain filtered data; and Step S102 in FIG. 1 includes extracting feature information from the filtered data.

The filtering the collected data may refer to: removing data in the collected data that has less influence on the environment identification, e.g., removing data having low validity, or removing data irrelevant to the calibration of the sensor.

In the embodiment of the present disclosure, due to the filtering of the collected data, it is able to reduce a computational burden in the subsequent steps, thereby reducing computing resource cost.

In a possible embodiment of the present disclosure, the collected data includes point cloud data, and the point cloud data includes position coordinate information of each data point in a data point set. The filtering the collected data to obtain the filtered data includes filtering the data point set in accordance with the position coordinate information to obtain the filtered data.

The data point set is a set of data points included in the collected data. Additionally, the point cloud data may further include an intensity value, e.g., reflectivity, of the data point in the data point set. In addition, the position coordinate information may be three-dimensional coordinate information.

The filtering the data point set in accordance with the position coordinate information may refer to: determining a position of each data point in accordance with the position coordinate information, and filtering the data point set in accordance with the position of each data point.

In the embodiment of the present disclosure, through filtering the data point set in accordance with the position coordinate information, it is able to improve a filtering performance.

In the embodiment of the present disclosure, the filtering may include at least one of: pass-through filtering, including deleting each data point in the data point set that is at a distance greater than or equal to a first predetermined threshold, the distance being a distance between a position of the data point represented by the position coordinate information and the sensor; outlier filtering, including deleting each outlier data point in the data point set, an average distance corresponding to the outlier data point being greater than or equal to a second predetermined threshold, the average distance corresponding to the outlier data point being an average of distances between data points within a predetermined range corresponding to the outlier data point and the outlier data point; or, height filtering, including deleting each data point in the data point set whose height coordinate value is less than or equal to a third predetermined threshold, the height coordinate value being included in the position coordinate information.

The first predetermined threshold may be preset in accordance with an empirical value, or may be set in accordance with parameter information of the sensor. For example, in some implementations, the method further includes obtaining the parameter information of the sensor, wherein the first predetermined threshold matches the parameter information.

The obtaining the parameter information of the sensor may refer to: reading configuration information of the device, so as to obtain the parameter information of the sensor.

That the first predetermined threshold matches the parameter information may refer to: the first predetermined threshold is used for filtering out data corresponding to the parameter information and having low validity, or is used for filtering out invalid data corresponding to the parameter information. For example, in case that the sensor is a radar sensor, the parameter information may be a radar beam quantity. For example, for a radar sensor having fewer beams, e.g., 16 beams, the point cloud is very sparse when an object is slightly remote from the radar sensor, and the data has low validity, as a result, the first predetermined threshold of the distance of pass-through filtering may be set to e.g., 20 m or 19 m, so as to filter out the data having low validity; while for the radar sensor having more beams (e.g., 24 beams or 32 beams), the first predetermined threshold may be set to 25 m, 30 m or the like.

In this way, since the first predetermined threshold matches the parameter information, it is able to further improve the filtering effect.

In the embodiment of the present disclosure, the data about the object remote from the sensor is filtered out through the pass-through filtering, so it is able to improve the accuracy of the identification result while reducing a computational burden in the subsequent steps.

The second predetermined threshold and the predetermined range may be set in advance, e.g., set in advance in accordance with an empirical value, or set in advance in accordance with a parameter and a type of the sensor.

The outlier filtering may refer to: performing neighborhood statistics analysis on each data point, i.e., calculating an average of distances between the data point and all neighboring points, so as to identify and delete the outlier data points. Assuming that the collected data is of a Gaussian distribution whose shape is determined by the average distance of each data point and the second predetermined threshold, the data point having an average distance greater than or equal to the second predetermined threshold is defined as the outlier data point and is removed from the data set.

In the embodiment of the present disclosure, due to the outlier filtering, it is able to filter out some outlier data points, thereby reducing a computational burden in the subsequent steps.

The third predetermined threshold may be set in advance, e.g., set in advance in accordance with an empirical value, or set in advance in accordance with a parameter and a type of the sensor.

Through the height filtering, it is able to filter out the data points with less height, e.g., data points on the lawn or ground, because these data points are usually useless for the calibration of the sensor.

In the embodiment of the present disclosure, through the height filtering, it is able to filter out the data point farther away from the sensor, thereby improving the accuracy of the identification result while reducing the computational burden in the subsequent steps.

It should be noted that, in case that two or three of the three manners of filtering are performed, an order of performing them will not be particularly limited, e.g., they may be performed sequentially or concurrently.

It should be also noted that, in the embodiments of the present disclosure, the data is not limited to including the point cloud data. For example, for an image sensor, the collected images may merely include image feature data rather than the position coordinate information, and the identification result is generated in accordance with feature information in the image feature data. For example, in case that the feature information in the image feature data indicates that there is a building or obstacle in the environment, the generated identification result is used for indicating the corresponding relationship that the environment meets the requirement of the calibration of the sensor. In case that the feature information in the image feature data indicates that there is no building or obstacle in the environment, the generated identification result is used for indicating the corresponding relationship that the environment does not meet the requirement of the calibration of the sensor.

In a possible embodiment of the present disclosure, Step S103 in FIG. 1 includes: identifying a geometrical feature contained in the collected data in accordance with the feature information; and generating the identification result of the environment in accordance with the geometrical feature contained in the collected data. In case that the geometrical feature contained in the collected data meets a predetermined condition for the calibration of the sensor, the corresponding relationship indicated by the identification result is that the environment meets a requirement of the calibration of the sensor, and in case that the geometrical feature contained in the collected data does not meet the predetermined condition for the calibration of the sensor, the corresponding relationship indicated by the identification result is that the environment does not meet the requirement of the calibration of the sensor.

The identifying the geometrical feature contained in the collected data in accordance with the feature information may refer to: identifying a quantity of geometrical features contained in the collected data in accordance with the feature information, or identifying a ratio of the geometrical features contained in the collected data to the collected data in accordance with the feature information.

It should be noted that, in case that this embodiment is combined with the above-mentioned embodiment of filtering, the identifying the geometrical feature contained in the collected data in accordance with the feature information may be identifying the geometrical feature contained in the filtered data in accordance with the feature information.

The predetermined condition for the calibration of the sensor may be a quantity of geometrical features or the ratio of the geometrical features. For example, if a quantity of geometrical features contained in the collected data exceeds a predetermined threshold, then the condition for the calibration of the sensor is met, otherwise the condition is not met. Optionally, if the ratio of the geometrical features contained in the collected data to the collected data exceeds a predetermined ratio, then the condition for the calibration of the sensor is met, otherwise the condition is not met.

In the embodiment of the present disclosure, whether the requirement of the calibration of the sensor is met by the environment may be determined in accordance with the geometrical feature, and the geometrical feature is conducive to the calibration of the sensor, so it is able to improve the environment identification accuracy.

In some implementations, the collected data includes a plurality of data regions, each data region includes a plurality of data points, and the feature information includes feature information of the data points in the plurality of data regions. The identifying the geometrical feature contained in the collected data in accordance with the feature information includes: identifying the geometrical feature contained in the collected data in accordance with the feature information of the data points in the plurality of data regions. With respect to each data region, in case that a similarity feature of the feature information of the plurality of data points in the data region meets a predetermined similarity condition, there is the geometrical feature in the data region, and in case that the similarity feature of the feature information of the plurality of data points in the data region does not meet the predetermined similarity condition, there is no geometrical feature in the data region.

The data regions may be divided randomly or divided in accordance with a predetermined rule, and different regions may have a same size or may have different sizes.

The predetermined similarity condition may be a predetermined similarity, or a predetermined quantity threshold of similar data points.

In the implementation, whether there is the geometrical feature in the data region can be accurately identified in accordance with the predetermined similarity condition, so as to improve the environment identification accuracy.

In some implementations, that the similarity feature of the feature information of the plurality of data points in the data region meets the predetermined similarity condition includes: similarity of the feature information of the plurality of data points in the data region is greater than or equal to a first predetermined similarity threshold, or a quantity of first data points in the data region is greater than or equal to a first predetermined quantity threshold, wherein similarity between the feature information of each first data point and the feature information of one or more other data points in the data region is greater than or equal to a second predetermined similarity threshold. That the similarity feature of the feature information of the plurality of data points in the data region does not meet the predetermined similarity condition includes: similarity of the feature information of the plurality of data points in the data region is less than or equal to a third predetermined similarity threshold, or a quantity of second data points in the data region is greater than or equal to a second predetermined quantity threshold, wherein similarity between the feature information of each second data point and the feature information of one or more other data points in the data region is less than or equal to a fourth predetermined similarity threshold.

The similarity of the feature information of the plurality of data points may refer to: average similarity of the feature information of the plurality of data points, or a median of the similarity of the feature information of the plurality of data points.

The first predetermined similarity threshold, the first predetermined quantity threshold, the second predetermined similarity threshold, the third predetermined similarity threshold, the second predetermined quantity threshold and the fourth predetermined similarity threshold may be set in advance in accordance with an empirical value or in accordance with a parameter of the sensor. The first predetermined similarity threshold may be the same as or different from the second predetermined similarity threshold, e.g., the first predetermined similarity threshold is lower than the second predetermined similarity threshold. The first predetermined quantity threshold may be the same as or different from the second predetermined quantity threshold, e.g., the first predetermined quantity threshold is higher than the second predetermined quantity threshold. The third predetermined similarity threshold may be the same as or different from the fourth predetermined similarity threshold, e.g., the third predetermined similarity threshold is lower than the fourth predetermined similarity threshold.

That the similarity of the feature information of the plurality of data points is greater than or equal to the first predetermined similarity threshold may be understood as that the feature information of the plurality of data points is similar to each other.

That the similarity of the feature information of the plurality of data points is less than or equal to the third predetermined similarity threshold may be understood as that the feature information of the plurality of data points is dissimilar to each other.

That the similarity between the feature information of the first data point and the feature information of one or more other data points in the data region is greater than or equal to the second predetermined similarity threshold may be understood as that the first data point is similar to the one or more other data points.

That the similarity between the feature information of the second data point and the feature information of one or more other data points in the data region is less than or equal to the fourth predetermined similarity threshold may be understood as that the similarity between the second data point and the one or more other data points is low, e.g., the second data point is completely unassociated with the one or more other data points.

In the implementation, through the first predetermined similarity threshold, the first predetermined quantity threshold, the second predetermined similarity threshold, the third predetermined similarity threshold, the second predetermined quantity threshold and the fourth predetermined similarity threshold, it is able to improve the accuracy of identifying the geometrical feature.

In a possible embodiment of the present disclosure, the method further includes at least one of: in case that the corresponding relationship indicated by the identification result is that the environment meets a requirement of the calibration of the sensor, performing a calibration operation on the sensor; or in case that the corresponding relationship indicated by the identification result is that the environment does not meet the requirement of the calibration of the sensor, controlling the device to move away from the environment.

The performing the calibration operation on the sensor may refer to: performing a self-calibration operation on the sensor, i.e., the calibration of the sensor is completed by the device by itself without the help from any other device. For example, a radar sensor is calibrated based on a positioning sensor and a visual sensor of the device.

The controlling the device to move away from the environment may refer to: controlling the device to move from the environment to another environment.

In some implementations, in case that the corresponding relationship indicated by the identification result is that the environment does not meet the requirement of the calibration of the sensor, the procedure may be ended.

The following description of the method in the embodiments of the present disclosure will be given by taking an autonomous vehicle as an example of the device and with reference to FIG. 2.

As shown in FIG. 2, data extraction 201 is performed on the environment by using a sensor of the vehicle, i.e., data is collected from the environment, and then pass-through filtering 202 and outlier filtering 203 are performed on the extracted data. In the pass-through filtering, configuration of the vehicle is extracted, so as to obtain parameter information of the sensor and then perform the pass-through filtering in accordance with the parameter information of the sensor. Next, an environmental feature is extracted from the filtered data, judgment 204 is performed in accordance with the environmental feature, and then an environment judgment result, i.e., the above-mentioned identification result, is outputted. The judgment result may indicate the corresponding relationship between the environment and the calibration of the sensor, e.g., whether the requirement of the calibration of the sensor is met or not.

In the embodiment of the present disclosure, FIG. 3 shows a specific implementation procedure. As shown in FIG. 3, the procedure includes: Step S301 of selecting a configuration of the vehicle and starting the sensor; Step S302 of activating an environment detection function; Step S303 of extracting data by sensor, i.e., collecting data from the environment; Step S304 of performing filtering on the sensor data, e.g., pass-through filtering and outlier filtering as mentioned above; Step 305 of extracting and counting environmental features, e.g., extracting the feature information and identifying the geometrical feature as mentioned above; and Step 306 of determining whether the environment meets the requirement, and generating the identification result as mentioned above.

In the embodiment of the present disclosure, the vehicle may identify the environment by itself once the vehicle is started, and during the identification, it is unnecessary for the user to move the vehicle, so the operation is very convenient.

According to the embodiments of the present disclosure, the identification result of the environment is generated in accordance with the feature information of the data collected by the sensor, so it is able to intelligently identify the environment, thereby improving the environment identification efficiency.

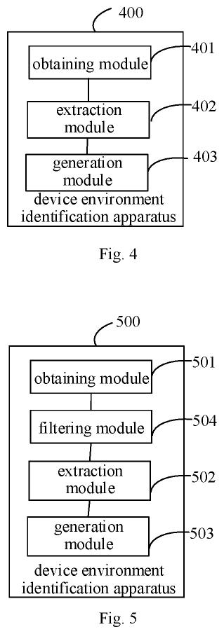

As shown in FIG. 4, the present disclosure provides a device environment identification apparatus 400, which includes: an obtaining module 401 configured to obtain data collected by a sensor of a device from an environment where the device is located; an extraction module 402 configured to extract feature information from the collected data; and a generation module 403 configured to generate an identification result of the environment in accordance with the feature information, the identification result being used for indicating a corresponding relationship between the environment and the calibration of the sensor.

Optionally, as shown in FIG. 5, a device environment identification apparatus 500 includes: an obtaining module 501 configured to obtain data collected by a sensor of a device from an environment where the device is located; a filtering module 504 configured to filter the collected data to obtain filtered data; an extraction module 502 configured to extract feature information from the filtered data; and a generation module 503 configured to generate an identification result of the environment in accordance with the feature information, the identification result being used for indicating a corresponding relationship between the environment and the calibration of the sensor.

Optionally, the collected data includes point cloud data, the point cloud data includes position coordinate information of each data point in a data point set, and the filtering module 504 is configured to filter the data point set in accordance with the position coordinate information to obtain the filtered data.

Optionally, the filtering includes at least one of: pass-through filtering, including deleting each data point in the data point set that is at a distance greater than or equal to a first predetermined threshold, the distance being a distance between a position of the data point represented by the position coordinate information and the sensor; outlier filtering, including deleting each outlier data point in the data point set, an average distance corresponding to the outlier data point being greater than or equal to a second predetermined threshold, the average distance corresponding to the outlier data point being an average of distances between data points within a predetermined range corresponding to the outlier data point and the outlier data point; or height filtering, including deleting each data point in the data point set whose height coordinate value is less than or equal to a third predetermined threshold, the height coordinate value being included in the position coordinate information.

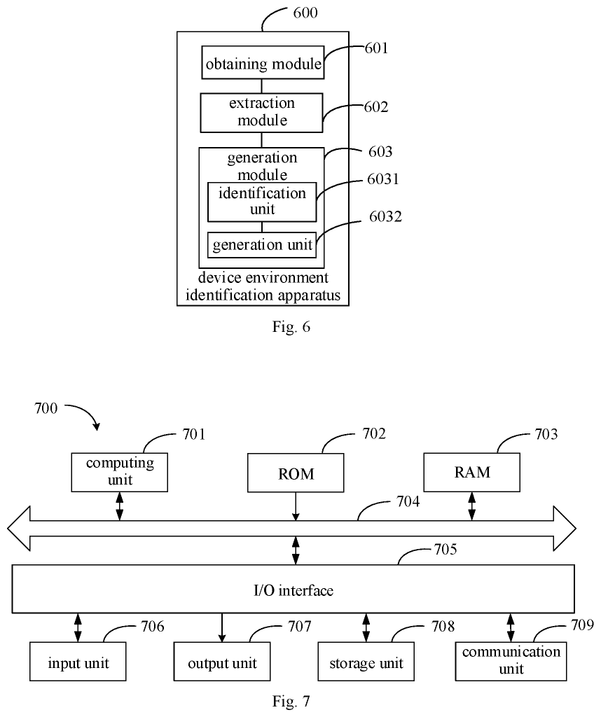

Optionally, as shown in FIG. 6, a device environment identification apparatus 600 includes: an obtaining module 601 configured to obtain data collected by a sensor of a device from an environment where the device is located; an extraction module 602 configured to extract feature information from the collected data; and a generation module 603, including an identification unit 6031 configured to identify a geometrical feature contained in the collected data in accordance with the feature information, and a generation unit 6032 configured to generate an identification result of the environment in accordance with the geometrical feature contained in the collected data. In case that the geometrical feature contained in the collected data meets a predetermined condition for the calibration of the sensor, the corresponding relationship indicated by the identification result is that the environment meets a requirement of the calibration of the sensor, and in case that the geometrical feature contained in the collected data does not meet the predetermined condition for the calibration of the sensor, the corresponding relationship indicated by the identification result is that the environment does not meet the requirement of the calibration of the sensor.

Optionally, the collected data includes a plurality of data regions, each data region includes a plurality of data points, and the feature information includes feature information of the data points in the plurality of data regions. The identification unit 6031 is configured to identify the geometrical feature contained in the collected data in accordance with the feature information of the data points in the plurality of data regions. With respect to each data region, in case that a similarity feature of the feature information of the plurality of data points in the data region meets a predetermined similarity condition, there is the geometrical feature in the data region, and in case that the similarity feature of the feature information of the plurality of data points in the data region does not meet the predetermined similarity condition, there is no geometrical feature in the data region.

Optionally, that the similarity feature of the feature information of the plurality of data points in the data region meets the predetermined similarity condition includes: similarity of the feature information of the plurality of data points in the data region is greater than or equal to a first predetermined similarity threshold, or a quantity of first data points in the data region is greater than or equal to a first predetermined quantity threshold, wherein similarity between the feature information of each first data point and the feature information of one or more other data points in the data region is greater than or equal to a second predetermined similarity threshold. That the similarity feature of the feature information of the plurality of data points in the data region does not meet the predetermined similarity condition includes: similarity of the feature information of the plurality of data points in the data region is less than or equal to a third predetermined similarity threshold, or a quantity of second data points in the data region is greater than or equal to a second predetermined quantity threshold, wherein similarity between the feature information of each second data point and the feature information of one or more other data points in the data region is less than or equal to a fourth predetermined similarity threshold.

Optionally, the device includes an autonomous vehicle or a robot device.

The device environment identification apparatus provided by the present disclosure is capable of implementing the above-mentioned device environment identification method with a same beneficial effect, which will not be particularly defined herein to avoid repetition.

The present disclosure further provides in some embodiments an electronic device, a readable storage medium and a computer program product.

The electronic device includes at least one processor, and a memory in communicative connection with the at least one processor and storing therein an instruction configured to be executed by the at least one processor. The at least one processor is configured to execute the instruction to implement the device environment identification method in the embodiments of the present disclosure.

The readable storage medium stores therein a computer instruction, and the computer instruction is configured to be executed by a computer to implement the device environment identification method in the embodiments of the present disclosure.

The computer program product includes a computer program, and the computer program is configured to be executed by a processor to implement the device environment identification method in the embodiments of the present disclosure.

The collection, storage and usage of personal information involved in the embodiments of the present disclosure comply with relevant laws and regulations, and do not violate the principle of the public order and good custom.

The present disclosure further provides in some embodiments an electronic device, a computer-readable storage medium and a computer program product.

FIG. 7 is a schematic block diagram of an exemplary electronic device 700 in which embodiments of the present disclosure may be implemented. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present disclosure described and/or claimed herein.

As shown in FIG. 7, the electronic device 700 includes a computing unit 701 configured to execute various actions and processes in accordance with computer programs stored in a read-only memory (ROM) 702 or computer programs loaded into a random access memory (RAM) 703 from a storage unit 708. Various programs and data required for the operation of the electronic device 700 may also be stored in the RAM 703. The computing unit 701, the ROM 702 and the RAM 703 are connected to each other via a bus 704. In addition, an input/output (I/O) interface 705 may also be connected to the bus 704.

Multiple components in the electronic device 700 are connected to the I/O interface 705. The multiple components include: an input unit 706, e.g., a keyboard, a mouse and the like; an output unit 707, e.g., a variety of displays, loudspeakers, and the like; a storage unit 708, e.g., a magnetic disk, an optic disc and the like; and a communication unit 709, e.g., a network card, a modem, a wireless transceiver, and the like. The communication unit 709 allows the electronic device 700 to exchange information/data with other devices through a computer network and/or other telecommunication networks, such as the Internet.

The computing unit 701 may be any general purpose and/or special purpose processing components having a processing and computing capability. Some examples of the computing unit 701 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 701 carries out the aforementioned methods and processes, e.g., the device environment identification method. For example, in some embodiments, the device environment identification method may be implemented as a computer software program tangibly embodied in a machine readable medium such as the storage unit 708. In some embodiments, all or a part of the computer program may be loaded and/or installed on the electronic device 700 through the ROM 702 and/or the communication unit 709. When the computer program is loaded into the RAM 703 and executed by the computing unit 701, one or more steps of the foregoing device environment identification method may be implemented. Optionally, in some other embodiments, the computing unit 701 may be configured in any other suitable manner (e.g., by means of firmware) to implement the device environment identification method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read-only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship to each other. The server may be a cloud server, a server of a distributed system, or a server combined with blockchain.

It should be noted that, all forms of processes shown above may be used, and steps thereof may be reordered, added or deleted. For example, as long as expected results of the technical solutions of the present disclosure can be achieved, steps set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. A device environment identification method, comprising:
obtaining data collected by a sensor of a device from an environment where the device is located;
extracting feature information from the collected data; and
generating an identification result of the environment in accordance with the feature information, the identification result being used for indicating a corresponding relationship between the environment and calibration of the sensor.

2. The device environment identification method according to claim 1, further comprising:
filtering the collected data to obtain filtered data,
wherein the extracting the feature information from the collected data comprises: extracting the feature information from the filtered data.

3. The device environment identification method according to claim 2, wherein the collected data comprises point cloud data, and the point cloud data comprises position coordinate information of each data point in a data point set, wherein the filtering the collected data to obtain the filtered data comprises:
filtering the data point set in accordance with the position coordinate information to obtain the filtered data.

4. The device environment identification method according to claim 3, wherein the filtering comprises at least one of:
pass-through filtering, comprising deleting each data point in the data point set that is at a distance greater than or equal to a first predetermined threshold, the distance being a distance between a position of the data point represented by the position coordinate information and the sensor;
outlier filtering, comprising deleting each outlier data point in the data point set, an average distance corresponding to the outlier data point being greater than or equal to a second predetermined threshold, the average distance corresponding to the outlier data point being an average of distances between data points within a predetermined range corresponding to the outlier data point and the outlier data point; or
height filtering, comprising deleting each data point in the data point set whose height coordinate value is less than or equal to a third predetermined threshold, the height coordinate value being comprised in the position coordinate information.

5. The device environment identification method according to claim 1, wherein the generating the identification result of the environment in accordance with the feature information comprises:
identifying a geometrical feature contained in the collected data in accordance with the feature information; and
generating the identification result of the environment in accordance with the geometrical feature contained in the collected data,
wherein in case that the geometrical feature contained in the collected data meets a predetermined condition for the calibration of the sensor, the corresponding relationship indicated by the identification result is that the environment meets a requirement of the calibration of the sensor, and in case that the geometrical feature contained in the collected data does not meet the predetermined condition for the calibration of the sensor, the corresponding relationship indicated by the identification result is that the environment does not meet the requirement of the calibration of the sensor.

6. The device environment identification method according to claim 5, wherein the collected data comprises a plurality of data regions, each data region comprises a plurality of data points, and the feature information comprises feature information of the data points in the plurality of data regions,
wherein the identifying the geometrical feature contained in the collected data in accordance with the feature information comprises: identifying the geometrical feature contained in the collected data in accordance with the feature information of the data points in the plurality of data regions,
wherein with respect to each data region, in case that a similarity feature of the feature information of the plurality of data points in the data region meets a predetermined similarity condition, there is the geometrical feature in the data region, and in case that the similarity feature of the feature information of the plurality of data points in the data region does not meet the predetermined similarity condition, there is no geometrical feature in the data region.

7. The device environment identification method according to claim 6, wherein that the similarity feature of the feature information of the plurality of data points in the data region meets the predetermined similarity condition comprises: similarity of the feature information of the plurality of data points in the data region is greater than or equal to a first predetermined similarity threshold, or a quantity of first data points in the data region is greater than or equal to a first predetermined quantity threshold, wherein similarity between the feature information of each first data point and the feature information of one or more other data points in the data region is greater than or equal to a second predetermined similarity threshold,
wherein that the similarity feature of the feature information of the plurality of data points in the data region does not meet the predetermined similarity condition comprises: similarity of the feature information of the plurality of data points in the data region is less than or equal to a third predetermined similarity threshold, or a quantity of second data points in the data region is greater than or equal to a second predetermined quantity threshold, wherein similarity between the feature information of each second data point and the feature information of one or more other data points in the data region is less than or equal to a fourth predetermined similarity threshold.

8. The device environment identification method according to claim 1, wherein the device comprises an autonomous vehicle or a robot device.

9. An electronic device, comprising at least one processor, and a memory in communicative connection with the at least one processor and storing therein an instruction configured to be executed by the at least one processor, wherein the at least one processor is configured to execute the instruction to implement following steps:
obtaining data collected by a sensor of a device from an environment where the device is located;
extracting feature information from the collected data; and
generating an identification result of the environment in accordance with the feature information, the identification result being used for indicating a corresponding relationship between the environment and calibration of the sensor.

10. The electronic device according to claim 9, wherein the at least one processor is configured to execute the instruction to further implement:
filtering the collected data to obtain filtered data,
wherein the extracting the feature information from the collected data comprises: extracting the feature information from the filtered data.

11. The electronic device according to claim 10, wherein the collected data comprises point cloud data, and the point cloud data comprises position coordinate information of each data point in a data point set, wherein the filtering the collected data to obtain the filtered data comprises:
filtering the data point set in accordance with the position coordinate information to obtain the filtered data.

12. The electronic device according to claim 11, wherein the filtering comprises at least one of:
pass-through filtering, comprising deleting each data point in the data point set that is at a distance greater than or equal to a first predetermined threshold, the distance being a distance between a position of the data point represented by the position coordinate information and the sensor;
outlier filtering, comprising deleting each outlier data point in the data point set, an average distance corresponding to the outlier data point being greater than or equal to a second predetermined threshold, the average distance corresponding to the outlier data point being an average of distances between data points within a predetermined range corresponding to the outlier data point and the outlier data point; or
height filtering, comprising deleting each data point in the data point set whose height coordinate value is less than or equal to a third predetermined threshold, the height coordinate value being comprised in the position coordinate information.

13. The electronic device according to claim 9, wherein the generating the identification result of the environment in accordance with the feature information comprises:
identifying a geometrical feature contained in the collected data in accordance with the feature information; and
generating the identification result of the environment in accordance with the geometrical feature contained in the collected data,
wherein in case that the geometrical feature contained in the collected data meets a predetermined condition for the calibration of the sensor, the corresponding relationship indicated by the identification result is that the environment meets a requirement of the calibration of the sensor, and in case that the geometrical feature contained in the collected data does not meet the predetermined condition for the calibration of the sensor, the corresponding relationship indicated by the identification result is that the environment does not meet the requirement of the calibration of the sensor.

14. The electronic device according to claim 13, wherein the collected data comprises a plurality of data regions, each data region comprises a plurality of data points, and the feature information comprises feature information of the data points in the plurality of data regions,
wherein the identifying the geometrical feature contained in the collected data in accordance with the feature information comprises: identifying the geometrical feature contained in the collected data in accordance with the feature information of the data points in the plurality of data regions,
wherein with respect to each data region, in case that a similarity feature of the feature information of the plurality of data points in the data region meets a predetermined similarity condition, there is the geometrical feature in the data region, and in case that the similarity feature of the feature information of the plurality of data points in the data region does not meet the predetermined similarity condition, there is no geometrical feature in the data region.

15. The electronic device according to claim 14, wherein that the similarity feature of the feature information of the plurality of data points in the data region meets the predetermined similarity condition comprises: similarity of the feature information of the plurality of data points in the data region is greater than or equal to a first predetermined similarity threshold, or a quantity of first data points in the data region is greater than or equal to a first predetermined quantity threshold, wherein similarity between the feature information of each first data point and the feature information of one or more other data points in the data region is greater than or equal to a second predetermined similarity threshold,
wherein that the similarity feature of the feature information of the plurality of data points in the data region does not meet the predetermined similarity condition comprises: similarity of the feature information of the plurality of data points in the data region is less than or equal to a third predetermined similarity threshold, or a quantity of second data points in the data region is greater than or equal to a second predetermined quantity threshold, wherein similarity between the feature information of each second data point and the feature information of one or more other data points in the data region is less than or equal to a fourth predetermined similarity threshold.

16. The electronic device according to claim 9, wherein the device comprises an autonomous vehicle or a robot device.

17. A non-transitory computer-readable storage medium storing therein a computer instruction, wherein the computer instruction is configured to be executed by a computer to implement the device environment identification method according to claim 1.

18. An autonomous vehicle comprising the electronic device according to claim 9.
